(19) United States
(12) Patent Application Publication
(10) Pub. No.: US 2010/0095661 A1
(43) Pub. Date: Apr. 22, 2010

(54) DRIVE SYSTEM AND METHOD FOR RECOVERING WASTE ENERGY FROM A VEHICLE

(75) Inventors: Jeffrey Hemphill, Copley, OH (US); Edmund Maucher, Jeromesville, OH (US)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/579,109

(22) Filed: Oct. 14, 2009

Related U.S. Application Data
(60) Provisional application No. 61/196,624, filed on Oct. 17, 2008.

(51) Int. Cl. F16D 31/00; F16D 31/02

(52) U.S. Cl. 60/327; 60/415; 60/414

(57) ABSTRACT

A drive system, including a torque converter with a housing arranged for connection to a combustion engine for a vehicle; and an air-operated motor, connected to the housing, for providing torque to the housing for the torque converter; or an air compressor, connected to the housing, for using torque from the housing to compress air. In one embodiment, the system includes a compressed air accumulator for providing compressed air to the air-operated motor; and a heat exchanger for transferring heat energy to compressed air provided to the air-operated motor from the accumulator. A drive system, including a combustion engine with a crankshaft; a plurality of pistons and cylinders for combusting fuel; and a cylinder and piston, the piston connected to the crankshaft. The system also includes a compressed gas accumulator for supplying compressed gas to the cylinder to operate the first piston to provide torque to the crankshaft.

### CROSS-REFERENCE TO RELATED APPLICATIONS

This application claims the benefit under 35 U.S.C. §119(e) of U.S. Provisional Application No. 61/196,624 filed Oct. 17, 2008, which application is incorporated herein by reference.

### FIELD OF THE INVENTION

The invention relates to means for recovering and using waste deceleration and heat energy from a vehicle to propel the vehicle.

### BACKGROUND OF THE INVENTION

Recovery and reuse of waste energy from a vehicle is known. However, such means for recovery and reuse are typically directed to elaborate steam or refrigeration systems.

### BRIEF SUMMARY OF THE INVENTION

The present invention broadly comprises a drive system, including a torque converter with a housing arranged for connection to a combustion engine for a vehicle; and an air-operated motor, connected to the housing, for providing torque to the housing for the torque converter; or an air compressor, connected to the housing, for using torque from the housing to compress air. In one embodiment, the system includes a compressed air accumulator for providing compressed air to the air-operated motor; and a heat exchanger for transferring heat energy to compressed air provided to the air-operated motor by the accumulator. In another embodiment during deceleration of the combustion engine the air-operated motor is for using torque from the housing for the torque converter to compress air. In a further embodiment, the system includes a compressed air accumulator for providing compressed air to the air-operated motor; a heat exchanger for transferring heat energy to compressed air provided to the air-operated motor by the accumulator; and a control valve connected to the heat exchanger, the air compressor, and the air-operated motor. In a first mode the valve enables flow from the accumulator through the heat exchanger to the air-operated motor and during deceleration, the valve blocks flow from the heat exchanger to the air-operated motor and enables flow from the air-operated motor to the accumulator.

The present invention also broadly comprises a drive system, including a combustion engine with a crankshaft; a plurality of pistons, connected to the crankshaft, and cylinders for combusting fuel; and a first cylinder and piston, the piston connected to the crankshaft. The system also includes a compressed gas accumulator for supplying compressed gas to the first cylinder to operate the first piston to provide torque to the crankshaft. In one embodiment, the system includes a heat exchanger for transferring heat energy to compressed gas provided to the first cylinder from the accumulator. In another embodiment, during deceleration of the combustion engine, the first cylinder and piston are for using torque from the crankshaft to compress gas for storage in the accumulator. In a further embodiment, the combustion engine includes a second cylinder and piston, the second piston connected to the crankshaft, for using torque from the crankshaft to compress gas for storage in the accumulator. In a yet another embodiment, the plurality of cylinders and pistons are for using torque from the crankshaft to compress gas for storage in the accumulator.

The present invention further broadly comprises a method of operating a torque converter for a vehicle.

It is a general object of the present invention to provide a means of using energy from deceleration and exhaust heat to motivate a vehicle.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic diagram of a present invention drive system;

FIG. 2 is a schematic diagram of a present invention drive system; and,

FIG. 3 is a schematic diagram of a present invention drive system

FIG. 4 is a table showing present invention results with three different engine configurations;

FIG. 5 is a chart showing temperatures in a present invention heat exchanger; and,

FIG. 6 is a P-V chart for a hot air engine.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

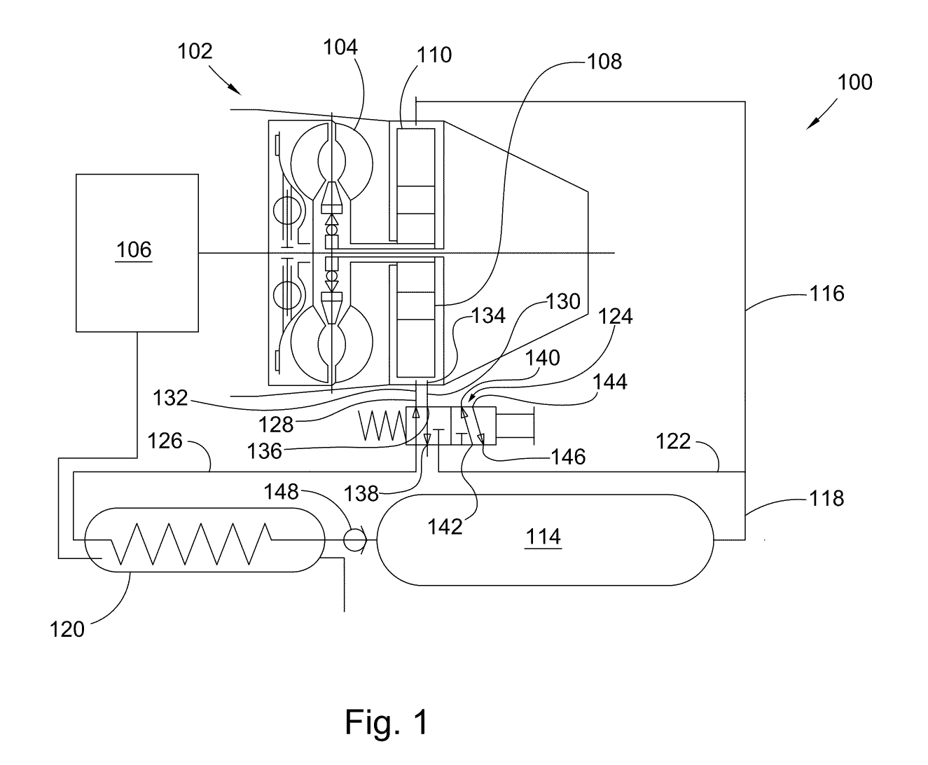

FIG. 1 is a schematic diagram of present invention drive system 100. System 100 includes torque converter 102 with housing 104 arranged for connection to a combustion engine, for example, engine 106, for a vehicle (not shown). In one embodiment, system 100 includes air-operated motor 108, connected to the housing. In another embodiment, system 100 includes air compressor 110 connected to the housing. The motor is for providing torque to the housing for the torque converter, in response to compressed air provided to the motor, as further described infra. The compressor is for using torque from the housing to compress air, for example, as described infra. The torque converter is arranged for connection to a transmission, for example, transmission 112.

In one embodiment, the system includes compressed air accumulator 114, in fluid communication with the air compressor, for example, via lines 116 and 118, for providing compressed air to the air-operated motor. In another embodiment, the system includes heat exchanger 120 for transferring heat energy from the engine to compressed air provided to the air-operated motor by the accumulator. The accumulator and the heat exchanger can be any accumulator or heat exchanger known in the art. During a coasting mode, the engine decelerates, for example, an operator (not shown) of the vehicle has removed their foot from an accelerator (not shown) for the engine, or the vehicle has been braked. Torque is still being supplied to the torque converter cover during the deceleration; however, this torque (and the energy in the torque) is wasted since in coasting mode, the intent is to slow the vehicle. In a further embodiment, during coasting mode, the air compressor or the air-operated motor is for using torque from the housing for the torque converter to compress air in the compressor or motor, respectively, which is stored in the accumulator. For example, line 116 connects the air compressor to line 118 to the accumulator and line 122 connects the motor to line 116.

In one embodiment, the system includes control valve 124 connected to, or in fluid communication with, the heat exchanger, for example, through line 126, the air compressor, for example, through lines 118 and 122, and the air-operated motor, for example, through lines 128 and 130, connected to ports 132 and 134, respectively for the motor. In one mode, for example, a drive mode in which it is desired to provide torque to the housing from the motor, the valve enables flow from the accumulator through the heat exchanger to the air-operated motor. Thus, line 126 is open to feed heated, compressed air through the valve to line 128 and port 132 to the motor, line 130 from the motor is connected to port 136 to exhaust air from the motor through port 138 in the valve, and line 122 from the compressor is closed. This is the mode shown in FIG. 1.

In coasting mode, the valve closes line 126 to block flow from the heat exchanger to the air-operated motor, connects line 128 with port 140 to draw air into the motor through port 142, and enables flow from the air-operated motor to the accumulator by connecting line 130 with port 144 and connecting line 122 with port 146. To shift from drive mode to coasting mode, the valve is switched to the left in FIG. 1. Check valve 148 prevents flow from the heat exchanger to the accumulator.

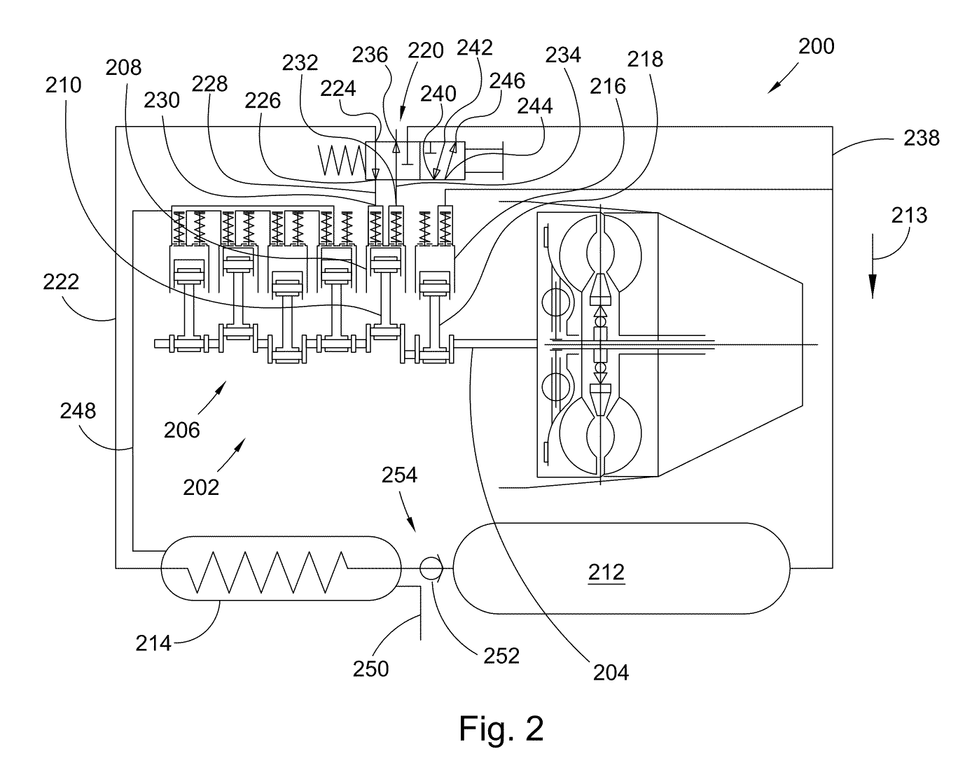

FIG. 2 is a schematic diagram of present invention drive system 200. System 200 includes combustion engine 202 with crankshaft 204, plurality 206 of pistons and cylinders for combusting fuel. The pistons are connected to the crankshaft. The system also includes cylinder 208 and piston 210, connected to the crankshaft, and compressed air accumulator 212. The accumulator is for supplying compressed air to cylinder 208 to operate piston 210 to provide torque to the crankshaft. That is, the compressed air causes the piston to displace in the cylinder to turn the crankshaft, for example, the compressed air displaces the piston in direction 213. The accumulator can be any accumulator known in the art.

In one embodiment, the system includes heat exchanger 214 for transferring heat energy to compressed air provided to cylinder 208 from the accumulator. The heat exchanger can be any heat exchanger known in the art. In another embodiment, the combustion engine includes cylinder 216 and piston 218. Piston 218 is connected to the crankshaft. Cylinder 216 and piston 218 use torque from the crankshaft to supply compressed air to the accumulator. That is, the piston is displaced in the cylinder by movement of the crankshaft to compress air in the cylinder.

In one embodiment, the system includes valve 220 to control operation of cylinder 208 and piston 210. In a drive mode (shown in FIG. 2), line 222 from the heat exchanger is connected to port 224 in the valve to enable flow of compressed air from the accumulator through the heat exchanger and port 226 to line 228 and port 230 of cylinder 208. Port 232 of cylinder 208 is connected to line 234 to enable exhaust air to exit cylinder 208 through port 236. Line 238 to the accumulator is blocked. In a coasting mode, the valve as shown in FIG. 2 is shifted to the left so that line 222 is blocked, port 240 is connected to line 228 and port 242 is open to enable intake of air to cylinder 208, and port 244 is connected to line 234 and port 246 is connected to line 238 to enable flow of compressed air from cylinder 208 to the accumulator.

In one embodiment, line 248 connects the exhaust ports for the cylinders in plurality 206 with the heat exchanger, and line 250 vents the exhaust gas feed through line 248 from the heat exchanger. Check valve 252 is disposed in line 254 between the accumulator and the heat exchanger to prevent flow from the heat exchanger to the accumulator.

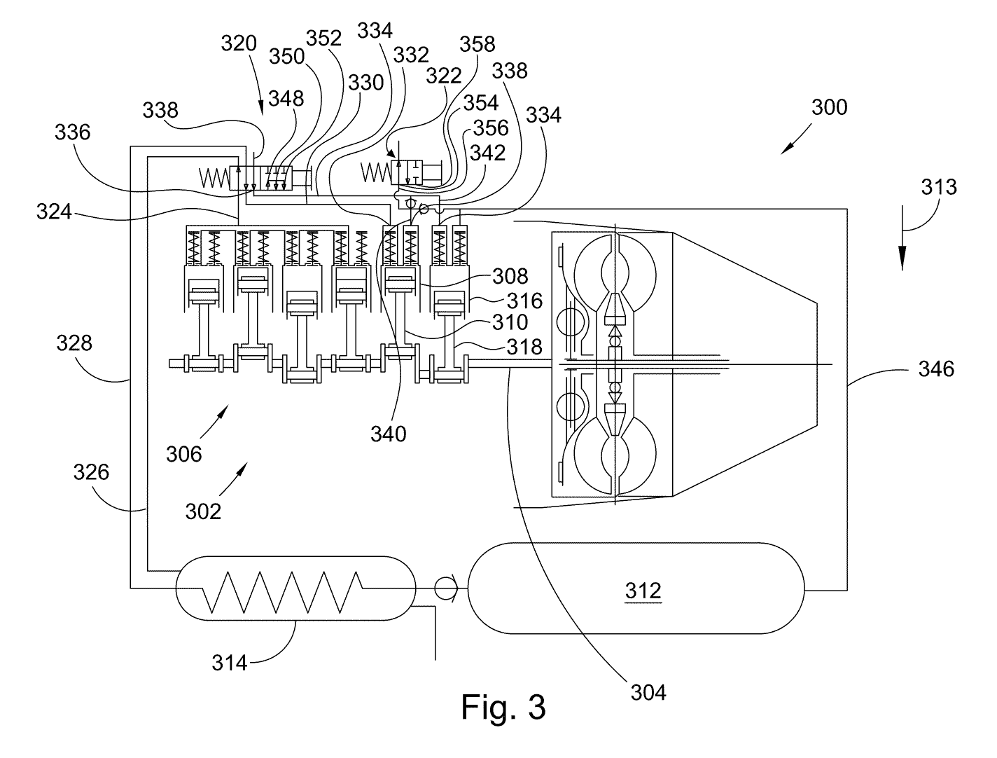

FIG. 3 is a schematic diagram of present invention drive system 300. System 300 includes combustion engine 302 with crankshaft 304, plurality 306 of pistons and cylinders for combusting fuel. The pistons are connected to the crankshaft. The system also includes cylinder 308 and piston 310, connected to the crankshaft, and compressed air accumulator 312. The accumulator is for supplying compressed air to cylinder 308 to operate piston 310 to provide torque to the crankshaft. That is, the compressed air causes the piston to displace in the cylinder to turn the crankshaft, for example, the compressed air displaces the piston in direction 313. The accumulator can be any accumulator known in the art.

In one embodiment, the system includes heat exchanger 314 for transferring heat energy to compressed air provided to cylinder 308 from the accumulator. The heat exchanger can be any heat exchanger known in the art. In another embodiment, the combustion engine includes cylinder 316 and piston 318. Piston 318 is connected to the crankshaft. In a coasting mode, plurality 306, cylinders 308 and 316 and pistons 310 and 318 use torque from the crankshaft to supply compressed air to the accumulator. That is, respective pistons are displaced in respective cylinders by movement of the crankshaft to compress air in the cylinders. In particular, plurality 306 performs an initial air compression step and cylinders 308 and 316 and pistons 310 and 318 further compress the air compressed by plurality 306.

In one embodiment, the system includes valves 320 and 322 to control operation of plurality 306, cylinders 308 and 316 and pistons 310 and 318. In a drive mode (shown in FIG. 3), line 324 from the exhaust ports for plurality 306 is connected to line 326 to feed exhaust gas from the plurality to the heat exchanger. Line 328 from the heat exchanger is connected to line 330 to enable flow of compressed air from the accumulator through the heat exchanger and port 332 to cylinder 308. Line 334 is connected to port 336 to enable intake of air to cylinder 316 through port 344 and line 342. Compressed air from cylinder 316 is fed to the accumulator via line 346. Port 354 of valve 322 is connected to line 356 to enable release of exhaust air from cylinder 308.

In a coasting mode, valve 320, as shown in FIG. 3, is shifted to the left so that line 324 is connected to port 348, which is connected to ports 350 and 352. Ports 350 and 352 are connected to lines 330 and 334, respectively, so that exhaust gases from plurality 306 are fed to cylinders 308 and 316. The exhaust gases fed through lines 330 and 334 have been compressed by plurality 306 as part of the initial air compression step noted supra. Port 358 of valve 322 is connected to line 356, which blocks the line at valve 322, directing compressed air from cylinder 308 to the accumulator via line 346.

The following should be viewed in light of FIG. 1. The following describes a present invention method for operating a torque converter for a vehicle. Although the method is presented as a sequence of steps for clarity, no order should be inferred from the sequence unless explicitly stated. A first step connects an air-operated motor to a housing for the torque converter, the housing arranged for connection to a combustion engine for a vehicle in which the torque converter is disposed and flows compressed air from an accumulator to the air-operated motor so that the air-operated motor supplies torque to the housing; or connects an air compressor to the housing, compresses, using the air compressor, air in response to torque from the housing, and flows compressed air from the air compressor to the accumulator.

In one embodiment, a second step flows exhaust heat from the combustion engine through a heat exchanger and transfers heat energy from the heat exchanger to compressed gas flowed to the gas-operated motor by the accumulator. In another embodiment, a third step decelerates the engine, compresses, using the air-operated motor, air in response to torque from the housing, and flows compressed air from the air-operated motor to the accumulator. In a further embodiment, a fourth step flows exhaust heat from the combustion engine through a heat exchanger; in a first mode, operates a valve to flow compressed air from the accumulator through the heat exchanger to the air-operated motor and to block flow from the air compressor into the valve. In yet another embodiment, a fifth step, during deceleration of the engine, operates a valve to block air flow from the accumulator to the air-operated motor and to flow compressed air from the air-operated motor to the accumulator.

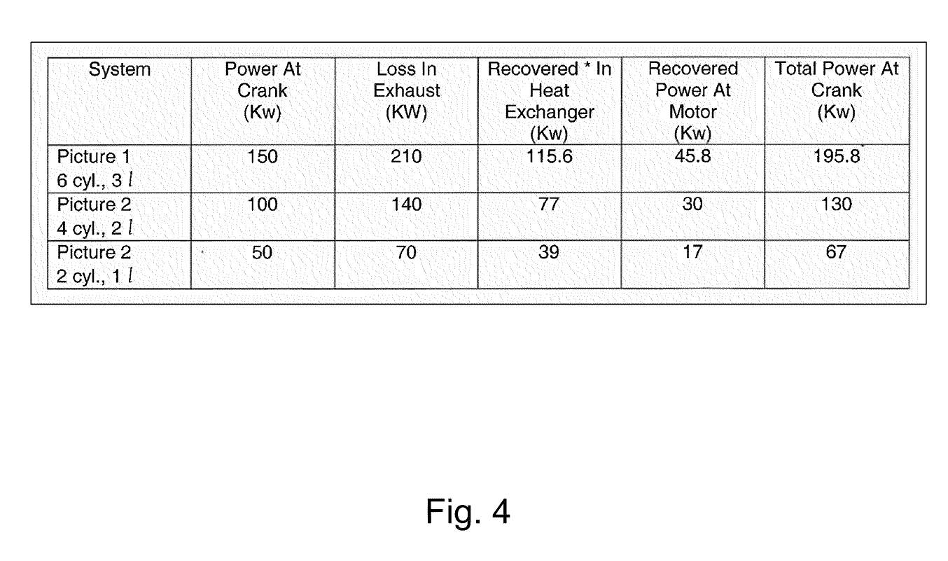

FIG. 4 is a table showing present invention results with three different engine configurations. It should be understood that the equations that follow are approximations based on the laws of thermodynamics and that one skilled in the art could present other and different calculations regarding the present invention without limiting the present invention. Further it should be understood that the calculations that follow are exemplary in nature and do not limit the spirit or scope of the claimed invention. The results shown in FIG. 4 are based on a maximum engine speed of 4000 rpm. The following power balance was assumed for the analysis: P crank=25%, P exhaust=35%, P coolant=20%, P radiation=20%. The results in the heat exchanger are based on an exchange area of 5 m². By increasing the area to 7.5 m², the recovered power increases by 9%.

Further improvements could be attained if the heat, wasted in the coolant system, could be recovered. In this case, the engine needed to be air cooled and the heat exchanged to the compressed air would take place in the engine. In this case, the recovered power could be increased by 57%.

The improvements from coasting energy recovery should be in between a mild to full electric hybrid, without the need for the heavy and expensive batteries. As an example, using an air tank with 0.5 m³ and 12.5 bar, 20 cold starts or 1700 m driving distance are feasible.

The following formulas and methods were used in the above analysis:

Power In Exhaust:

$${P}_{exh} = \frac{{P}_{crank}}{.25} \times .35$$

Exhaust Volume Flow:

$${\mathring{V}}_{exh} = \frac{Displ .}{1000} \times \frac{4000}{2 \times 60} [ \frac{{m}^{3}}{sec} ]$$

Exhaust Mass Flow:

$${\mathring{m}}_{exh} = V \times ϑ [ \frac{Kg}{sec} ]$$

Exhaust Temperature:

$${t}_{exh} = \frac{{P}_{exh}}{{\mathring{m}}_{exh} \times {C}_{p}} [ ° C . ]$$

Loss from Radiation −10%

tₑₓₕ×0.9[° C.]

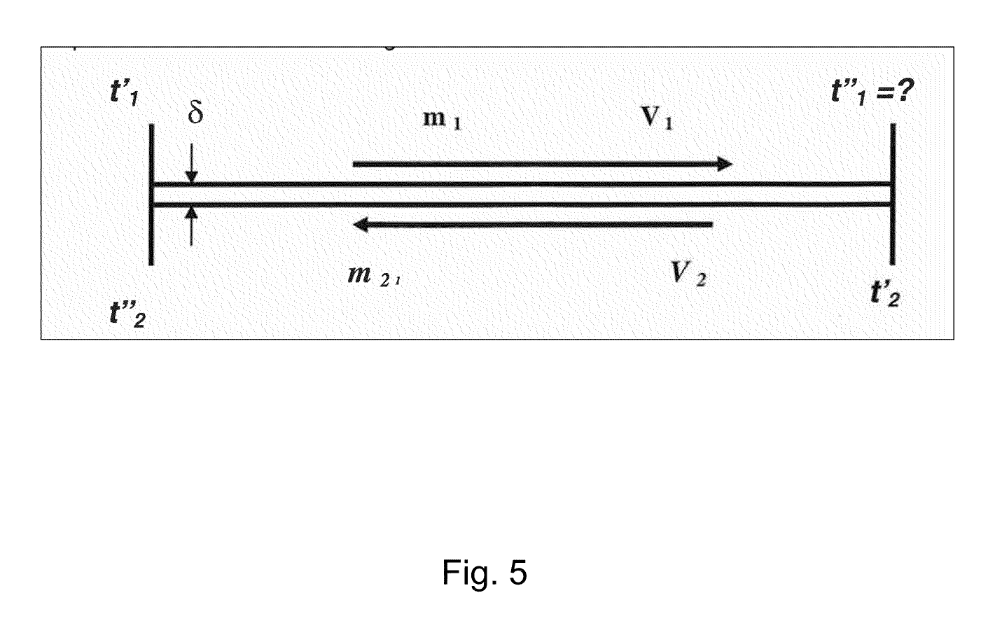

FIG. 5 is a chart showing temperatures in a present invention heat exchanger. The following formulas and calculations are applicable to FIG. 5:

Exchanged Power:

$${Q}_{z} = k \times A \times Δ$$

$$k = \frac{1}{\sum ( 1 / {α}_{1} , δ / λ , {α}_{2} )}$$

$$using V 1 = V 2 = 25 m \text{/} sec$$

$${α}_{1} = {α}_{2} = 316 Kj \text{/} {m}^{2 } {h}^{′} grd$$

$$k = 158.14 Kj \text{/} {m}^{2} hgrd$$

Average Temperature Difference:

$$Δ t = \frac{{t}_{1}^{′} - {t}_{2}^{′′} - Σ ( {t}_{1}^{′′} , {t}_{2}^{′} )}{ln \frac{{t}_{1}^{′} - {t}_{2}^{′′}}{{t}_{1}^{′′} - {t}_{{}^{′} 2}^{′}}}$$

$$where$$

$${t}_{1}^{′′} = {t}_{1}^{′} - χ ( {t}_{1}^{′} - {t}_{2}^{′} ) \frac{\mathring{m} \times {C}_{P 1}}{{\mathring{m}}_{2} \times {C}_{P 2}}$$

$${t}_{2}^{′} = {t}_{1}^{′} - χ ( {t}_{1}^{′} - {t}_{2}^{′} )$$

$$χ = \frac{1 - {l}^{- E}}{\frac{{m}_{2} \times {C}_{P 2}}{{m}_{1} \times {C}_{P 1}} - {l}^{- E}}$$

$$E = ( 1 - \frac{{\mathring{m}}_{1} \times {C}_{P 1}}{{\mathring{m}}_{2} \times {C}_{P 2}} ) \times \frac{K \times A}{{\mathring{m}}_{1} \times {C}_{P 1}}$$

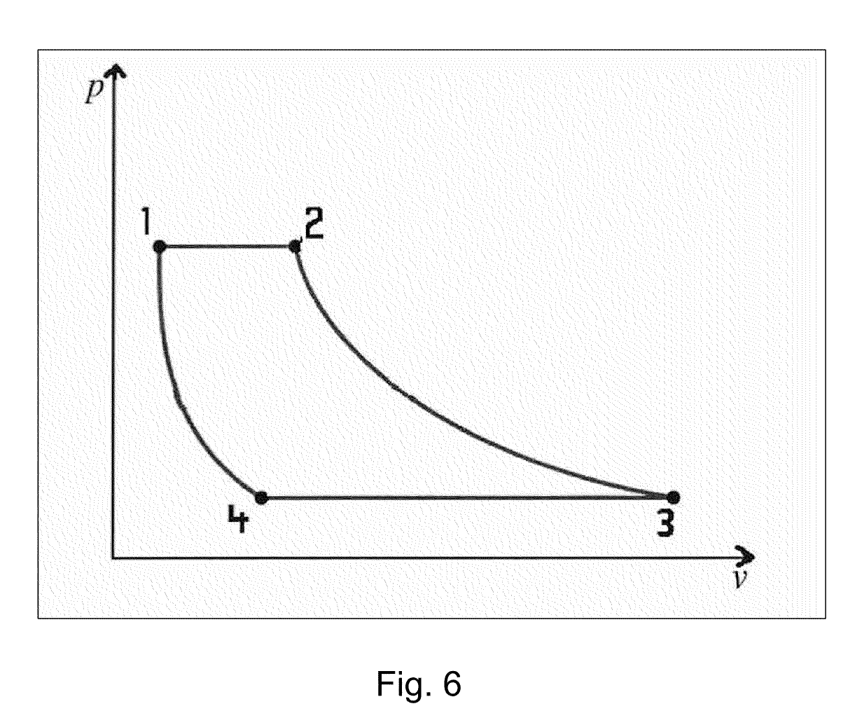

FIG. 6 is a P-V chart for a hot air engine. Efficiency for the motor can be calculated using the chart. The following formulas and calculations are applicable to FIG. 6:

$${η}_{th} = 1 - \frac{{T}_{4}}{{T}_{1}} = 1 - {( \frac{{P}_{o}}{P} )}^{\frac{κ - 1}{κ}}$$

$$using$$

$${P}_{o} = 1 bar$$

$$P = 12.5 bar$$

$${η}_{th} = 44 \%$$

Recovered power from exhaust: P_{rec}=Q_{z}×ηₜₕ

Storage for coast energy recovery:

$$c = P \times v [ Kj ]$$

$$v = 12.5 bar , V = .5 {m}^{3}$$

$$\begin{matrix}{Q}_{c} = 12.5 \times .5 \times 10 , 000 \\ = 624 [ Kj ]\end{matrix}$$

Engine starts until pressure drops to 50% with:

starting power=8 Kw

starting time=2 sec

starting energy=16 KJ

resulting start=20

Driving distance D using cold compressed air. Example:

$$v = 50 Km \text{/} h , G = 1800 Km$$

$$\begin{matrix}P = {F}_{rd} \times v + {F}_{A} \times v \\ = 5 Kw \\ = \frac{5 Kj}{sec}\end{matrix}$$

$$time becomes t = \frac{{Q}_{c}}{P} = 125 sec$$

$$D = v \times t = 1700 m$$

The following should be viewed in light of FIGS. 2 and 3. The following describes a present invention method for method of operating a torque converter for a vehicle. Although the method is presented as a sequence of steps for clarity, no order should be inferred from the sequence unless explicitly stated. A first step stores compressed gas in a compressed gas accumulator; a second step flows compressed gas from the accumulator to a cylinder for a combustion engine; and a third step displaces a piston within the cylinder to transfer torque to the crankshaft. In one embodiment, a fourth step flows exhaust heat from the combustion engine through a heat exchanger and transfers heat energy from the heat exchanger to compressed gas flowed to the cylinder from the accumulator. In another embodiment, a fifth step decelerates the engine; displaces, using torque from the crankshaft, the piston within the cylinder; compresses gas within the cylinder; and flows the compressed gas from the cylinder to the accumulator.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A drive system, comprising:
a torque converter with a housing arranged for connection to a combustion engine for a vehicle; and,
an air-operated motor, connected to the housing, for providing torque to the housing for the torque converter; or,
an air compressor, connected to the housing, for using torque from the housing to compress air.

2. The system of claim 1 further comprising:
a compressed air accumulator, in fluid communication with the air compressor, for providing compressed air to the air-operated motor; and,
a heat exchanger for transferring heat energy to compressed air provided to the air-operated motor from the accumulator.

3. The system of claim 1 further comprising a compressed air accumulator for providing compressed air to the air-operated motor, wherein during deceleration of the combustion engine the air-operated motor is for using torque from the housing for the torque converter to compress air for storage in the accumulator.

4. The system of claim 3 further comprising:
a heat exchanger for transferring heat energy to compressed air provided to the air-operated motor from the accumulator; and,
a control valve in fluid communication with the heat exchanger, the air compressor, and the air-operated motor; wherein in a first mode the valve enables flow from the accumulator through the heat exchanger to the air-operated motor and wherein during deceleration, the valve blocks flow from the heat exchanger to the air-operated motor and enables flow from the air-operated motor to the accumulator.

5. A drive system, comprising:
a torque converter with a housing arranged for connection to a combustion engine for a vehicle;
a compressed air accumulator;
an air-operated device connected to the housing for the torque converter, wherein in a first mode the air-operated device is for receiving compressed air from the accumulator to provide torque to the housing for the torque converter and wherein in a second mode the combustion engine is decelerating and the air-operated device is for compressing air for storage in the accumulator.

6. The system of claim 5 further comprising a heat exchanger for transferring heat energy from an exhaust system for the combustion engine to compressed air provided to the air-operated device from the accumulator.

7. The system of claim 6 further comprising a control valve connected to the heat exchanger, the air compressor, and the air-operated device, wherein in the first mode the valve enables flow from the accumulator through the heat exchanger to the air-operated device and wherein during deceleration, the valve blocks flow from the heat exchanger to the air-operated motor and enables flow from the air-operated motor to the accumulator.

8. A drive system, comprising:
a combustion engine with:
a crankshaft;
a plurality of respective pistons and cylinders for combusting fuel, the respective pistons connected to the crankshaft; and,
a first cylinder and piston, the first piston connected to the crankshaft; and,
a compressed gas accumulator for supplying compressed gas to the first cylinder to operate the first piston to provide torque to the crankshaft.

9. The system of claim 8 further comprising a heat exchanger for transferring heat energy to compressed gas provided to the first cylinder from the accumulator.

10. The system of claim 8 wherein during deceleration of the combustion engine the first cylinder and piston are for using torque from the crankshaft to compress air for storage in the accumulator.

11. The system of claim 8 wherein the combustion engine includes a second cylinder and piston, the second piston connected to the crankshaft, for using torque from the crankshaft to compress gas for storage in the accumulator.

12. The system of claim 8 wherein the plurality of cylinders and pistons are for using torque from the crankshaft to compress gas for storage in the accumulator.

13. A method of operating a torque converter for a vehicle, comprising:
connecting an air-operated motor to a housing for the torque converter, the housing arranged for connection to a combustion engine for a vehicle in which the torque converter is disposed; and,
flowing compressed air from an accumulator to the air-operated motor so that the air-operated motor supplies torque to the housing; or,
connecting an air compressor to the housing;
compressing, using the air compressor, air in response to torque from the housing; and,
flowing compressed air from the air compressor to the accumulator.

14. The method of claim 13 further comprising:
flowing exhaust heat from the combustion engine through a heat exchanger; and,
transferring heat energy from the heat exchanger to compressed air flowed to the air-operated motor from the accumulator.

15. The method of claim 13 further comprising:
decelerating the engine;
compressing, using the air-operated motor, air in response to torque from the housing; and,
flowing compressed air from the air-operated motor to the accumulator.

16. The method of claim 13 further comprising:
flowing exhaust heat from the combustion engine through a heat exchanger;
in a first mode, operating a valve to flow compressed air from the accumulator through the heat exchanger to the air-operated motor and to block flow from the air compressor into the valve; and,
during deceleration of the engine:
operating the valve to block air flow from the accumulator to the air-operated motor;
compressing air in the air-operated motor; and,
flowing compressed air from the air-operated motor to the accumulator.

17. A method of operating a torque converter for a vehicle, comprising:
storing compressed gas in a compressed gas accumulator;
flowing compressed gas from the accumulator to a cylinder for a combustion engine; and,
displacing a piston within the cylinder to transfer torque to the crankshaft.

18. The method of claim 17 further comprising:
flowing exhaust heat from the combustion engine through a heat exchanger; and,
transferring heat energy from the heat exchanger to compressed gas flowed to the cylinder from the accumulator.

19. The method of claim 17 further comprising:
decelerating the engine;
displacing, using torque from the crankshaft, the piston within the cylinder;
compressing gas within the cylinder; and,
flowing the compressed gas from the cylinder to the accumulator.
